(19) United States
(12) Patent Application Publication
(10) Pub. No.: US 2026/0128412 A1
(43) Pub. Date: May 7, 2026

(54) AUXILIARY HEATING DEVICE FOR INCREASING A VEHICLE BATTERY TEMPERATURE

(71) Applicant: International Truck Intellectual Property Company, LLC, Lisle, IL (US)

(72) Inventors: Scott Benedict, Redford, MI (US); Lianmin Huang, Saline, MI (US)

(73) Assignee: International Truck Intellectual Property Company, LLC, Lisle, IL (US)

(21) Appl. No.: 18/937,672

(22) Filed: Nov. 5, 2024

(51) Int. Cl. H01M 10/6567; H01M 10/48; H01M 10/615; H01M 10/625; H01M 10/6571

(52) U.S. Cl. CPC H01M 10/6567; H01M 10/486; H01M 10/615; H01M 10/625; H01M 10/6571

(57) ABSTRACT

An auxiliary heating device for increasing a vehicle battery temperature is provided for increasing a battery temperature of a battery in a vehicle by heating a coolant temperature of a coolant. The auxiliary heating device for increasing a vehicle battery temperature may include an auxiliary heating device, coolant duct, battery, warming pad, temperature determination module, and power source.

### FIELD OF THE INVENTION

The present disclosure relates to an auxiliary heating device for increasing a vehicle battery temperature. More particularly, the disclosure relates to increasing a battery temperature of a battery in a vehicle by heating a coolant temperature of a coolant.

### BACKGROUND

The widespread adoption of electric vehicles (EVs) is hampered in extreme cold climates due to the limitations of the EV batteries, particularly Lithium-Ion batteries. At temperatures below freezing, these batteries struggle to perform two critical functions: efficiently accepting a charge and delivering sufficient power for driving. This significantly reduces an EV's range and usability. Currently, drivers in cold regions must rely on inconvenient methods like waiting for extended periods for the battery to warm up naturally through ambient temperature rise, or by pre-conditioning the vehicle in a heated space. These limitations discourage potential EV adoption and restrict the operational effectiveness of existing EVs in frigid environments. Furthermore, the inability to charge or drive in extreme cold can pose safety concerns, leaving drivers stranded in harsh conditions.

Therefore, a need exists to solve the deficiencies present in the prior art. What is needed is a device to keep a battery within a nominal operating temperature range. What is needed is a device to directly heat a coolant duct with an external heating device. What is needed is a device that may use various external or internal power sources to supply heat to a battery. What is needed is a device that will allow for a minimal heating time to increase the temperature of the battery when ambient temperatures are below −30 degrees Celsius.

### SUMMARY

An aspect of the disclosure advantageously provides a device to keep a battery within a nominal operating temperature range. An aspect of the disclosure advantageously provides a device to directly heat a coolant duct with an external heating device. An aspect of the disclosure advantageously provides a device that may use various external or internal power sources to supply heat to a battery. An aspect of the disclosure advantageously provides a device that will allow for a minimal heating time to increase the temperature of the battery when ambient temperatures are below −30 degrees Celsius.

Accordingly, the disclosure may feature an auxiliary heating device for increasing a coolant temperature of a coolant to affect a battery temperature of a battery for a vehicle. The auxiliary heating device may comprise a warming pad and a temperature determination module. The warming pad may have a heating surface to at least partially surround a section of a coolant duct that may transport the coolant to the battery, wherein the warming pad may selectively heat at least part of the coolant by applying heat to the coolant duct via a heating mechanism that may generate the heat from electrical power received from a power source. The temperature determination module may determine whether the battery temperature is within a nominal operating range. When the battery temperature is below the nominal operating range, the warming pad may then operatively provide the heat to the coolant.

In another aspect, at least part of the warming pad may be applied to a first coolant duct section of the coolant duct situated near a battery coolant input.

In another aspect, at least part of the warming pad may be applied to a second coolant duct section of the coolant duct situated near a coolant heater output.

In another aspect, at least part of the warming pad may be applied to a first coolant duct section of the coolant duct situated near a battery coolant input, and at least part of the warming pad may be applied to a second coolant duct section of the coolant duct situated near a coolant heater output.

In another aspect, the warming pad may increase the coolant temperature by conduction through at least part of the coolant duct.

In another aspect, the warming pad may further comprise an insulating surface located opposite to the heating surface.

In another aspect, the power source may comprise MAINS power.

In another aspect, the power source may comprise a DC automotive battery.

In another aspect, the temperature determination module may receive temperature information regarding the coolant temperature.

In another aspect, the temperature determination module may receive temperature information regarding the battery temperature from the battery.

Accordingly, the disclosure may feature an auxiliary heating device for increasing a coolant temperature of a coolant to affect a battery temperature of a battery for a vehicle. The auxiliary heating device may comprise a warming pad and a temperature determination module. The warming pad may have an insulating surface opposite to a heating surface to at least partially surround a section of a coolant duct that transports the coolant to the battery, wherein the warming pad may selectively heat at least part of the coolant by applying heat to the coolant duct via a heating mechanism that may generate the heat from electrical power received from a power source comprising a DC automotive battery. The temperature determination module may determine whether the battery temperature is within a nominal operating range. Additionally, when the battery temperature is below the nominal operating range, the warming pad may operatively provide the heat to the coolant.

In another aspect, at least part of the warming pad may be applied to a first coolant duct section of the coolant duct situated near a battery coolant input, and at least part of the warming pad may be applied to a second coolant duct section of the coolant duct situated near a coolant heater output.

In another aspect, the temperature determination module may receive temperature information regarding the battery temperature from the battery.

Accordingly, the disclosure may feature an auxiliary heating device for increasing a coolant temperature of a coolant to affect a battery temperature of a battery for a vehicle. The auxiliary heating device may comprise a warming pad and a temperature determination module. The warming pad may have an insulating surface opposite to a heating surface to at least partially surround a section of a coolant duct that transports the coolant to the battery, wherein the warming pad may selectively heat at least part of the coolant via conduction through the section of the coolant duct. The temperature determination module may determine whether the battery temperature is within a nominal operating range by receiving temperature information regarding the battery temperature from the battery. Additionally, when the battery temperature is below the nominal operating range, the heating surface may operatively provide heat to the coolant.

In another aspect, the warming pad may further comprise a heating mechanism that may generate the heat from electrical power received from a power source. The power source may comprise MAINS power and/or a DC automotive battery.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a schematic view of a cooling loop for a vehicular battery, according to an embodiment of this disclosure.

FIG. 2 is a perspective view of an auxiliary heating device, according to an embodiment of this disclosure.

FIG. 3 is a perspective view of an auxiliary heating device used in a cooling loop for a vehicular battery, according to an embodiment of this disclosure.

FIG. 4 is a graph view of an illustrative example of a battery temperature over time, according to an embodiment of this disclosure.

FIG. 5 is a graph view of an illustrative example of an activation of an auxiliary heating device over time, according to an embodiment of this disclosure.

FIG. 6 is a graph view of an illustrative example of a coolant temperature over time, according to an embodiment of this disclosure.

FIG. 7 is a flowchart view of an illustrative operation of activating an auxiliary heating device in a vehicle, according to an embodiment of this disclosure.

FIG. 8 is a flowchart view of an illustrative operation of activating an auxiliary heating device and a supplementary heating device in a vehicle, according to an embodiment of this disclosure.

### DETAILED DESCRIPTION

The following disclosure is provided to describe various embodiments of an auxiliary heating device for increasing a vehicle battery temperature. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term “warming pad,” as it is used throughout this disclosure, is defined as a malleable object used to apply heat to a localized area. The term “coolant,” as it is used throughout this disclosure, is defined as a liquid that circulates through a vehicle's battery to regulate the battery's temperature. The term “nominal operating range,” as it is used throughout this disclosure, is defined as a range of temperatures where a device is designed to function within its specified performance parameters. The term “coolant temperature,” as it is used throughout this disclosure, is defined as a measure of how hot or cold the liquid circulating through a vehicle's battery is. The term “battery temperature,” as it is used throughout this disclosure, is defined as a measure of how hot or cold the device that gives the vehicle power is.

Various aspects of the present disclosure will now be described in detail, without limitation. In the following disclosure, an auxiliary heating device for increasing a vehicle battery temperature will be discussed. Those of skill in the art will appreciate alternative labeling of the an auxiliary heating device for increasing a vehicle battery temperature as a system and method for managing battery temperature in a vehicle using auxiliary coolant heating, vehicle battery thermal management system with auxiliary coolant heater, battery temperature control device for vehicles with auxiliary coolant heating function, auxiliary coolant heater for enhanced battery thermal regulation in a vehicle, the invention, or other similar names. Skilled readers should not view the inclusion of any alternative labels as limiting in any way.

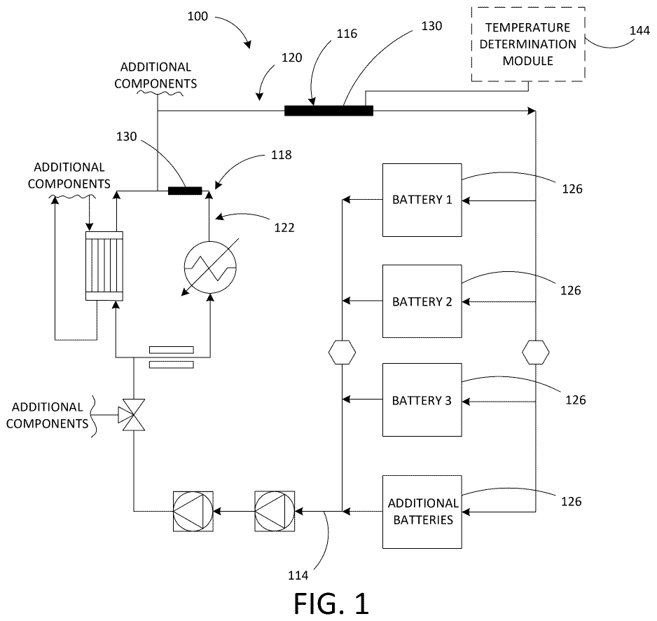

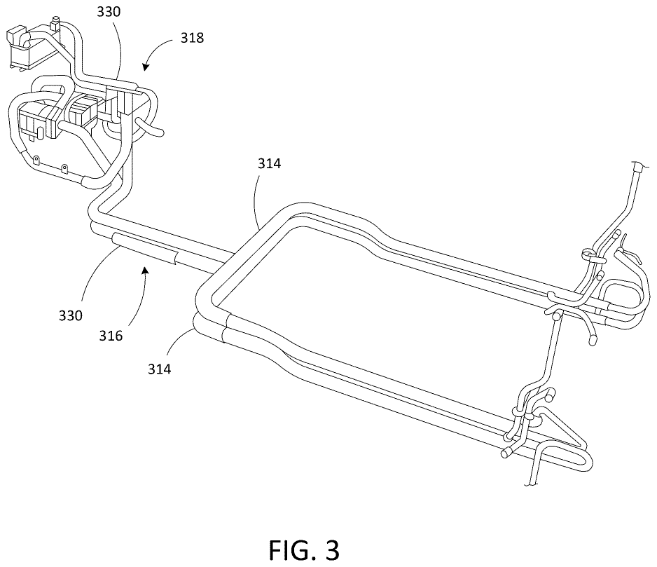

Referring now to FIGS. 1-8, an auxiliary heating device 100, 200 for increasing a vehicle battery temperature will now be discussed in more detail. The auxiliary heating device for increasing a vehicle battery temperature may include an auxiliary heating device 100, 200, coolant duct 114, 214, 314, battery 126, warming pad 130, 230, 330, temperature determination module 144, power source 242, and additional components that will be discussed in greater detail below. The auxiliary heating device 100, 200 for increasing a vehicle battery temperature may operate one or more of these components interactively with other components for increasing a battery temperature of a battery 126 in a vehicle by heating a coolant temperature of a coolant.

The auxiliary heating device 100, 200 will now be discussed in greater detail. FIGS. 1-3 highlight examples of the auxiliary heating device, which may also be shown in other figures.

Generally, the auxiliary heating device 100, 200 may comprise a warming pad 130, 230, 330 and a temperature determination module 144, both of which will be discussed in greater detail below. As previously mentioned, the auxiliary heating device 100, 200 may be used for increasing a battery temperature of a battery 126. In some embodiments, the auxiliary heating device 100, 200 may be used to supplement operation of a coolant system, which may be connected to the battery to traditionally cool batteries to prevent a battery temperature from exceeding a nominal operating range in vehicles. The auxiliary heating device 100, 200 may increase a coolant temperature of a coolant to affect the battery temperature of a battery 126, for example, by providing additional heat to a battery that has not yet reached the nominal operating range.

In various embodiments, the temperature determination module 144 of the auxiliary heating device 100, 200 may determine whether the battery temperature is within a nominal operating range. If the temperature determination module 144 determines that the battery temperature is not within the nominal operating range, then the warming pad 130, 230, 330 may be activated. In some embodiments, the warming pad 130, 230, 330 may selectively heat at least part of the coolant by applying heat to the coolant duct 114, 214, 314 that may provide heat to the coolant, which may provide heat to the battery 126.

In various embodiments, the temperature determination module 144 may continuously compare the battery temperature of the battery 126 to the nominal operating range. For example, if the battery temperature is below the nominal operating range, the warming pad 130, 230, 330 may be activated. However, if the battery temperature is within the nominal operating range, the warming pad 130, 230, 330 may be deactivated. This process will be discussed in greater detail below, however, those skilled in the art will appreciate the various processes that may occur for the temperature determination module 144 to determine whether the battery temperature is within a nominal operating range, after having the benefit of this disclosure.

The coolant duct 114, 214, 314 will now be discussed in greater detail. FIGS. 1-3 highlight examples of the coolant duct, which may also be shown in other figures.

In various embodiments, the coolant duct 114, 214, 314 may exist as a duct that may at least partially be filled with coolant that allows for a liquid to be used for heat transfer when the coolant duct 114, 214, 314 is inside, nearby, or next to a vehicle element. In most embodiments, the vehicle element includes a battery 126 of the vehicle. Examples of coolant substances that may be used include, but are not limited to, an ethylene glycol-water mixture, a propylene glycol-water mixture, and/or dielectric fluids. Those skilled in the art will appreciate the various coolants that may be used to cool and/or warm a battery 126, after having the benefit of this disclosure.

In some embodiments, the coolant duct 114, 214, 314 may create a loop from the battery 126 to a heat transfer section and back to the battery 126. The heat transfer section may include a chiller and/or a heater, without limitation. The chiller may cool the coolant located inside the coolant duct 114, 214, 314 to a certain temperature, while the heater may heat the coolant located inside the coolant duct 114, 214, 314 to a certain temperature. Those skilled in the art, however, will appreciate the various mechanisms that may exist within the chiller and/or heater for the chiller and/or heater to fulfill its desired purpose, after having the benefit of this disclosure. The coolant loop may also include other elements, such as pumps to accelerate the coolant from the battery 126 section to the heat transfer section and/or from the heat transfer section to the battery 126 section, without limitation. Those skilled in the art will appreciate the various other elements that may be added into the coolant loop, after having the benefit of this disclosure.

Additionally, in various embodiments, the coolant loop may include coolant temperature sensors. The coolant temperature sensor may measure the coolant temperature. Once measured, the temperature determination module 144, which will be discussed in greater detail below, may receive temperature information regarding the coolant temperature. The coolant temperature sensor may be advantageously located near the battery 126. More than one coolant temperature sensor may be located on the coolant loop. The coolant temperature sensor may be located in and/or on the coolant duct 114, 214, 314 right before the coolant duct 114, 214, 314 enters the battery 126. In the same or different embodiment, the coolant temperature sensor may be located in and/or on the coolant duct 114, 214, 314 right after the coolant duct 114, 214, 314 exits the battery 126. Those skilled in the art will appreciate various other locations the coolant temperature sensor may be located within the coolant loop, such as near the pumps, near the heat transfer section, near the warming pad(s), and/or other locations after having the benefit of this disclosure. In some embodiments, the coolant temperature sensors may be present within the coolant loop before adding an auxiliary heating device 100, 200 to the vehicle, while in other embodiments, the coolant temperature sensors may be added after the manufacturing of the vehicle has been completed.

In various embodiments, the coolant loop may be attached to one or more additional coolant loops that may provide other benefits for the vehicle. These include, but are not limited to, a BEV thermal system, and/or a cabin HVAC unit. However, those skilled in the art will appreciate the other coolant loops that may be attached, after having the benefit of this disclosure.

The battery 126 will now be discussed in greater detail. FIG. 1 highlights an example of the battery, which may also be shown in other figures.

As previously mentioned, the auxiliary heating device 100, 200 allows for the battery 126 to increase its temperature to a nominal operating range, so that the battery 126 may safely operate when ambient conditions are below a certain temperature. In some embodiments, the nominal operating range for a battery 126 may be below −30 degrees Celsius. However, those skilled in the art will appreciate the various optimal nominal operating ranges for the battery 126 may differ according to battery specifications after having the benefit of this disclosure. Skilled artisans will additionally appreciate that any given low temperature examples are provided to clearly describe an embodiment enabled by this disclosure and not to limit it to one specific example.

In various embodiments, the battery 126 may have a battery temperature, which may be measured by a battery temperature sensor located inside the battery 126 of the vehicle. In some embodiments, the battery temperature sensor may be present within the battery 126 before adding an auxiliary heating device 100, 200 to the vehicle, while in other embodiments, the battery temperature sensor may be added after the manufacturing of the vehicle has been completed.

In other embodiments, the temperature determination module 144, which will be discussed in greater detail below, may receive the temperature information from the battery sensor regarding the battery temperature of the battery 126. However, those skilled in the art will appreciate other elements that may collect the temperature information from the battery sensor regarding the battery temperature of the battery 126, after having the benefit of this disclosure, for example, a temperature sensor, thermocouple, thermistor, semiconductor-based sensor, and/or other sensor types consistent with the scope and spirit of this disclosure.

In the same or different embodiments, more than one battery 126 may exist within a vehicle. In those embodiments, the coolant duct 114, 214, 314 may split into multiple coolant ducts at one or more locations, so that each battery 126 can have at least one coolant duct 114, 214, 314 running through it. In some embodiments, once at least one coolant duct 114, 214, 314 has gone through at least one battery 126, the coolant ducts may join back with the other coolant ducts, forming one main coolant duct 114, 214, 314 again. Those skilled in the art, however, will appreciate the various configurations of coolant ducts and batteries that the vehicle may have, after having the benefit of this disclosure.

The warming pad 130, 230, 330 will now be discussed in greater detail. FIGS. 1-3 highlight examples of the warming pad, which may also be shown in other figures.

In various embodiments, the warming pad 130, 230, 330 may at least partially surround a section of the coolant duct 114, 214, 314 to selectively increase a coolant temperature of the coolant to ultimately affect a battery temperature of a battery 126 of a vehicle. Those skilled in the art will appreciate the other benefits and/or uses that the warming pad 130, 230, 330 may have on other parts of the vehicle, after having the benefit of this disclosure.

In embodiments, the warming pad 130, 230, 330 may comprise a heating surface 232. The heating surface 232 may advantageously face the coolant duct 114, 214, 314 to apply heat to the coolant duct 114, 214, 314 to affect the temperature of the coolant. Thus, in various embodiments, the heating surface 232 may advantageously allow for quick and thorough heat transfer from the warming pad 130, 230, 330 to the coolant duct 114, 214, 314. The heating surface 232 may be comprised of one or more materials, including, but not limited to, fabric, foam, felt, and/or other materials. However, those skilled in the art will appreciate the various materials that may be used for the heating surface 232 of the warming pad 130, 230, 330, after having the benefit of this disclosure.

In the same or other embodiments, the warming pad 130, 230, 330 may also comprise an insulating surface 234. The insulating surface 234 may exist on an opposite surface to the heating surface 232. Thus, in various embodiments, the insulating surface 234 may advantageously allow for minimal or close-to-zero heat transfer from the warming pad 130, 230, 330 to the ambient air and/or from the ambient air to the warming pad 130, 230, 330 through the insulating surface 234. The insulating surface 234 may be comprised of one or more materials, including, but not limited to, fiberglass, rockwool, cellulose, and/or rigid board. Those skilled in the art will appreciate the various materials that may be used for the insulating surface 234 of the warming pad 130, 230, 330, after having the benefit of this disclosure.

In various embodiments, the warming pad 130, 230, 330 may further comprise a heating mechanism 240. The heating mechanism 240 may be located at the heating surface 232 and/or inside the warming pad 130, 230, 330 near the heating surface 232. Those skilled in the art will appreciate various locations for the heating mechanism 240 in the warming pad 130, 230, 330, after having the benefit of this disclosure. In some embodiments, the heating mechanism 240 may be positioned between the heating surface 232 and the insulating surface 234. In some embodiments, the heating mechanism 240 may be located on or in at least part of the heating surface 232, while in other embodiments, the heating mechanism 240 may extend about the entire length of the warming pad 130, 230, 330.

In other embodiments, the heating mechanism 240 may be electrically connected to a power source 242 and/or temperature determination module 144. Those skilled in the art will appreciate the various electrical connections that may exist between the heating mechanism 240, power source 242, temperature determination module 144, and/or other elements, after having the benefit of this disclosure.

In embodiments, the heating mechanism 240 may advantageously generate heat from electrical power received from a power source 242, after being controlled to do so by the temperature determination module 144. However, those skilled in the art will appreciate the various other ways that the heating mechanism 240 may provide heat for at least part of the heating surface 232, after having the benefit of this disclosure.

In some embodiments, the warming pad 130, 230, 330 may increase the coolant temperature via conduction through at least part of the coolant duct 114, 214, 314. In other embodiments, the warming pad 130, 230, 330 may use other methods of heat transfer, such as convection and/or radiation, without limitation. However, those skilled in the art will appreciate the various methods of heat transfer that the warming pad 130, 230, 330 may use to increase the coolant temperature, after having the benefit of this disclosure.

In various embodiments, the warming pad 130, 230, 330 may be located in one or more locations within a coolant loop. For example, at least part of the warming pad 130, 230, 330 may be applied to a first coolant duct section 116, 316 of the coolant duct 114, 214, 314, which may be situated near a battery coolant input 120. More specifically, the warming pad 130, 230, 330 may be located right before the coolant duct 114, 214, 314 enters the battery 126. In the same or other examples, at least part of the warming pad 130, 230, 330 may be applied to a second coolant duct section 118, 318 of the coolant duct 114, 214, 314, which may be situated near a coolant heater output 122. More specifically, this may be located right after the coolant duct 114, 214, 314 leaves the heater within the heat transfer section of the coolant loop. Those skilled in the art, however, will appreciate various other locations of the warming pad 130, 230, 330 within the coolant loop, without limitation.

The temperature determination module 144 will now be discussed in greater detail. FIG. 1 highlights an example of the temperature determination module, which may also be shown in other figures.

As previously mentioned, a temperature determination module 144 may be used to determine whether the battery temperature is within a nominal operating range. In embodiments, when the battery temperature is below the nominal operating range, the temperature determination module 144 may activate the warming pad 130, 230, 330 to operatively provide heat to the coolant. Those skilled in the art, however, will appreciate other mechanisms that may be included by the temperature determination module 144 to determine whether the battery temperature is within a nominal operating range after having the benefit of this disclosure.

In embodiments, the temperature determination module 144 may be electrically connected to the heating mechanism 240 to allow for a direct enablement and/or disablement of the application of heat. In the same or other embodiments, the temperature determination module 144 may also be connected to a power source 242, which will be discussed in greater detail below. Those skilled in the art will appreciate various connections may be provided between the temperature determination module 144 and other elements, without limitation.

In one embodiment, the temperature determination module 144 may compare the ambient temperature, such as may be received from an ambient temperature sensor to the nominal operating range to determine whether the battery temperature needs to be raised. Those skilled in the art will appreciate other inputs may be used to assist the temperature determination module 144 with determining whether to activate the warming pad 130, 230, 330 that are consistent with the scope and spirit of this disclosure, without limitation.

To allow the temperature determination module 144 to determine whether the warming pad 130, 230, 330 needs to be activated and/or deactivated, various computer systems may exist within the temperature determination module 144, such as memory, storage, various software, and/or a central processing unit, without limitation. Example systems may be provided by an onboard computer of a vehicle onto which a device enabled by this disclosure is installed. Alternatively, the temperature determination module 144 may include sensors configured to operate directly with the temperature determination module 144, without limitation. In additional examples, a multitude of sensors may be used to determine temperature information through various vehicle-based and discrete temperature sensing systems, without limitation.

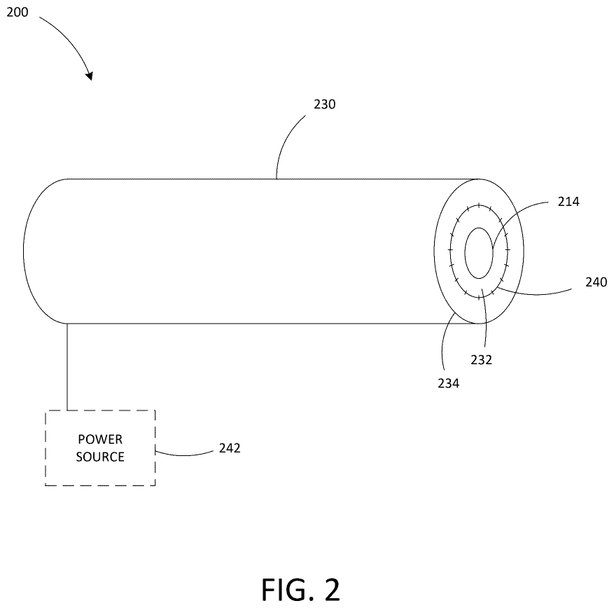

The power source 242 will now be discussed in greater detail. FIG. 2 highlights an example of the power source, which may also be shown in other figures.

In various embodiments, the heating mechanism 240 may generate heat from electrical power received from a power source 242. In the same or other embodiments, the temperature determination module 144 may also be connected to a power source 242. Illustrative power sources may include MAINS power, which may be provided via an electrical power grid and/or wall outlet, DC power provided by automotive batteries included by the vehicle, and/or other power sources that would be apparent to those of skill in the art.

In one embodiment, the auxiliary heating device 100, 200 may use an external power source 242, such as MAINS power, also referred to as the standard alternating current (AC) electricity delivered through the power grid, as the power source 242. In embodiments where MAINS power is used, the auxiliary heating device 100, 200 may comprise an electrical connection point, such as a plug fitting on the vehicle. In this embodiment, the user may plug an electrical power cord from a MAINS power plug fitting, such as an outlet in a garage, to the plug fitting in a vehicle. MAINS power may advantageously be used when the vehicle is in a parked state, but at least part of the electrical systems are turned on. Those skilled in the art, however, will appreciate the various situations in which MAINS power may best be used with the auxiliary heating device 100, 200, after having the benefit of this disclosure.

In the same or different embodiment, the auxiliary heating device 100, 200 may use a power source 242 provided by the vehicle, such as a DC automotive battery and/or a power bank, without limitation. As will be appreciated by those of skill in the art, DC automotive batteries may be provided as low voltage systems, for example using 12 volts, or high voltage systems, for example using 48 volts, without limitation. In one example, a low voltage DC automotive system may include 12-volt batteries that may also supply power for lights, infotainment systems, and operating vehicle electronics. Example low voltage battery chemistry may include lead-acid batteries, without limitation.

In another example, a high voltage DC automotive system may include 48-volt batteries, which may be provided independently or in compliment to low voltage battery systems, to deliver equivalent power with decreased current demands, which may advantageously reduce the need for bulky wiring and enable more efficient power distribution. In at least one embodiment including a DC automotive battery as a power source, a dual-voltage architecture may combine both 12-volt and 48-volt systems with a DC-DC converter to transfer between the two systems, ensuring compatibility and optimal utilization of both battery types for supplying the electrical power to the warming pad 130, 230, 330, without limitation. This hybrid approach may advantageously maximize efficiency, reduce weight, and enable the integration of other advanced features in vehicles.

In embodiments where a DC automotive battery is used, the auxiliary heating device 100, 200 may comprise an electrical connection to one or more DC automotive batteries located inside the vehicle. In embodiments where an internal power bank is used, the auxiliary heating device 100, 200 may comprise an electrical connection to one or more power banks located inside the vehicle. Those skilled in the art will appreciate additional ways a connection between the auxiliary heating device 100, 200 and an interior power source 242 may exist, after having the benefit of this disclosure.

In operation, a method may be provided for increasing a battery temperature of a battery in a vehicle by heating a coolant temperature of a coolant. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

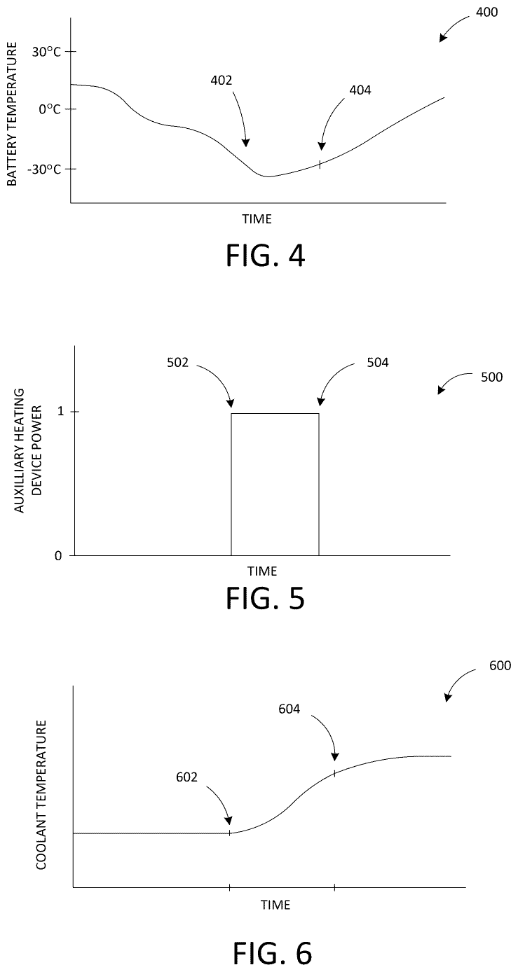

Referring now to graph 400 of FIG. 4, an illustrative example of battery temperature versus time is shown, without limitation. Beginning at time zero, the battery temperature starts at around 15 degrees Celsius, however, the battery temperature begins to decrease until it reaches time mark 402. At time mark 402, the battery temperature has gone beyond the nominal operating range-below −30 degrees Celsius. Since the battery temperature is outside the nominal operating range, the auxiliary heating device is turned on, beginning to warm the coolant. After time mark 402, the battery temperature begins to rise again. At time mark 404, the battery temperature is back within the nominal operating range, so the auxiliary heating device is turned off.

Referring now to graph 500 of FIG. 5, an illustrative example of auxiliary heating device power versus time is shown, without limitation. Beginning at time zero, since the battery temperature is within nominal operating range, the auxiliary heating device is off. At time mark 502, the battery temperature is outside the nominal operating range, so the auxiliary heating device is turned on. Once the battery temperature begins to rise within the nominal operating range, the auxiliary heating device is turned back off, at time mark 504.

Referring now to graph 600 of FIG. 6, an illustrative example of coolant temperature versus time is shown, without limitation. Beginning at time zero, since the battery temperature is within nominal operating range, the auxiliary heating device is off, and the coolant temperature is stable. At time mark 602, when the battery temperature is outside the nominal operating range, the auxiliary heating device is turned on, which begins to warm the coolant, thus the increase in coolant temperature is shown after time mark 602. Once the battery temperature has risen within the nominal operating range, at time mark 604, the auxiliary heating device is turned off, and, therefore, stops heating the coolant. Thus, after time mark 604, the coolant temperature no longer received supplemental heat and maintains itself within the nominal operating range.

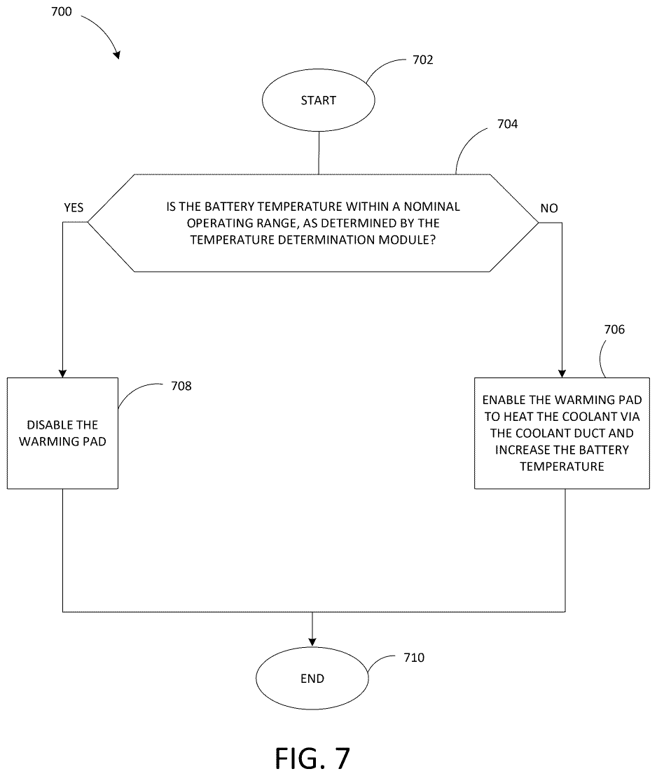

Referring now to flowchart 700 of FIG. 7, an example method for a single illustrative operation of activating an auxiliary heating device in a vehicle will be described, without limitation. Starting with Block 702, the operation may begin by asking whether the battery temperature is within a nominal operating range, as determined by the temperature determination module (Block 704). The temperature determination module of the auxiliary heating device receives the temperature information regarding the battery temperature and determines whether that is within or outside the nominal operating range. Next, if the answer to Block 704 is “no”, then the warming pad is enabled to heat the coolant via the coolant duct, ultimately increasing the battery temperature (Block 706). At this stage, the heating mechanism of the warming pad may use electrical power from a power source to heat the coolant duct via conduction. Heating the coolant duct allows for the coolant to increase in temperature. Otherwise, if the answer to Block 704 is “yes”, then the warming pad is disabled (Block 708). The operation ends at Block 710. Flowchart 700 shows a simple diagram illustrating a single check within the auxiliary heating device. People skilled in the art will realize that this check could be performed multiple times to ensure that the battery temperature may always be within a nominal operating range.

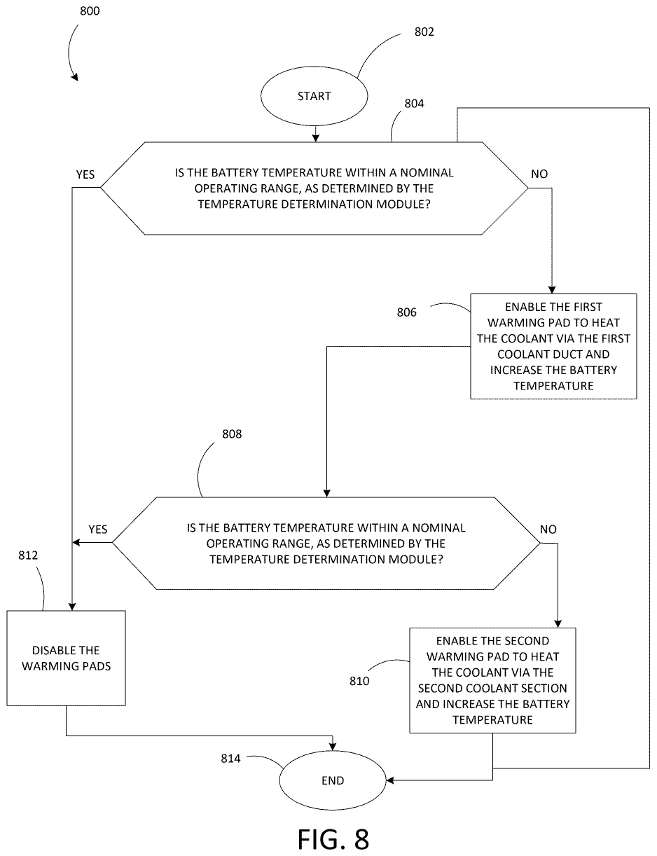

Referring now to flowchart 800 of FIG. 8, an example method for an illustrative operation of activating a first and second auxiliary heating device will be described, without limitation. Starting with Block 802, the operation may begin by asking whether the battery temperature is within a nominal operating range, determined by the temperature determination module (Block 804). The temperature determination module of the auxiliary heating device receives the temperature information regarding the battery temperature and determines whether that is within or outside the nominal operating range. Next, if the answer to Block 804 is “no”, then the first warming pad is enabled to heat the coolant via the first coolant duct section, ultimately increasing the battery temperature (Block 806). If the answer to Block 804 is “yes”, then the auxiliary heating device will disable the warming pads (Block 812).

Still referring to flowchart 800 of FIG. 8, after the operation of Block 806, the auxiliary heating device may again ask whether the battery temperature is within a nominal operating range, determined by the temperature determination module (Block 808). Then, if the answer to Block 808 is “no”, then the second warming pad is enabled to heat the coolant via the second coolant duct section, ultimately increasing the battery temperature (Block 810). If the answer to Block 808 is “yes”, the auxiliary heating device may be instructed to disable the warming pads (Block 812). After Block 810, the operation may loop back to Block 804 to begin the flowchart process again. Alternatively, after Block 810, the operation may conclude. After the operations of Block 812 and/or optionally Block 810, the operation may end at Block 814.

What is claimed is:

1. An auxiliary heating device for increasing a coolant temperature of a coolant to affect a battery temperature of a battery for a vehicle, comprising:
a warming pad having a heating surface to at least partially surround a section of a coolant duct that transports the coolant to the battery, wherein the warming pad selectively heats at least part of the coolant by applying heat to the coolant duct via a heating mechanism that generates the heat from electrical power received from a power source;
a temperature determination module to determine whether the battery temperature is within a nominal operating range; and
wherein when the battery temperature is below the nominal operating range, the warming pad operatively provides the heat to the coolant.

2. The auxiliary heating device of claim 1, wherein at least part of the warming pad is applied to a first coolant duct section of the coolant duct situated near a battery coolant input.

3. The auxiliary heating device of claim 1, wherein at least part of the warming pad is applied to a second coolant duct section of the coolant duct situated near a coolant heater output.

4. The auxiliary heating device of claim 1, wherein at least part of the warming pad is applied to a first coolant duct section of the coolant duct situated near a battery coolant input; and
wherein at least part of the warming pad is applied to a second coolant duct section of the coolant duct situated near a coolant heater output.

5. The auxiliary heating device of claim 1, wherein the warming pad increases the coolant temperature by conduction through at least part of the coolant duct.

6. The auxiliary heating device of claim 1, wherein the warming pad further comprises an insulating surface located opposite to the heating surface.

7. The auxiliary heating device of claim 1, wherein the power source comprises MAINS power.

8. The auxiliary heating device of claim 1, wherein the power source comprises a DC automotive battery.

9. The auxiliary heating device of claim 1, wherein the temperature determination module receives temperature information regarding the coolant temperature.

10. The auxiliary heating device of claim 1, wherein the temperature determination module receives temperature information regarding the battery temperature from the battery.

11. An auxiliary heating apparatus to affect a battery temperature of a battery device for increasing a coolant temperature of a coolant, comprising:
a warming pad having an insulating surface opposite to a heating surface to at least partially surround a section of a coolant duct that transports the coolant to the battery, wherein the warming pad selectively heats at least part of the coolant by applying heat to the coolant duct via a heating mechanism that generates the heat from electrical power received from a power source comprising a DC automotive battery;
a temperature determination module to determine whether the battery temperature is within a nominal operating range; and
wherein when the battery temperature is below the nominal operating range, the warming pad operatively provides the heat to the coolant.

12. The auxiliary heating apparatus of claim 11, wherein at least part of the warming pad is applied to a first coolant duct section of the coolant duct situated near a battery coolant input; and
wherein at least part of the warming pad is applied to a second coolant duct section of the coolant duct situated near a coolant heater output.

13. The auxiliary heating apparatus of claim 11, wherein the temperature determination module receives temperature information regarding the battery temperature from the battery.

14. An auxiliary heating device for increasing a battery temperature of a battery for a vehicle, comprising:
a warming pad having an insulating surface opposite to a heating surface to at least partially surround a section of a coolant duct that transports coolant to the battery, wherein the warming pad selectively heats at least part of the coolant via conduction through the section of the coolant duct;
a temperature determination module to determine whether the battery temperature is within a nominal operating range by receiving temperature information regarding the battery temperature from the battery; and
wherein when the battery temperature is below the nominal operating range, the heating surface operatively provides heat to the coolant.

15. The auxiliary heating device of claim 14, wherein the warming pad further comprises a heating mechanism that generates the heat from electrical power received from a power source; and
wherein the power source comprises MAINS power and/or a DC automotive battery.
